(19) United States
(12) Patent Application Publication
(10) Pub. No.: US 2024/0123341 A1
(43) Pub. Date: Apr. 18, 2024

(54) METHOD, APPARATUS, ELECTRONIC DEVICE AND STORAGE MEDIUM FOR COMBAT CONTROL

(71) Applicant: Beijing Zitiao Network Technology Co., Ltd., Beijing (CN)

(72) Inventors: Chi LI, Beijing (CN); Xueying DU, Beijing (CN); Guoan HAN, Beijing (CN); Yutong YANG, Beijing (CN); Jiaqi SHI, Beijing (CN); Bei SHI, Beijing (CN); Hongliang LI, Beijing (CN)

(21) Appl. No.: 18/485,975

(22) Filed: Oct. 12, 2023

(30) Foreign Application Priority Data
Oct. 13, 2022 (CN) 202211252942.X

(51) Int. Cl. A63F 13/45; A63F 13/822

(52) U.S. Cl. CPC A63F 13/45; A63F 13/822

(57) ABSTRACT

A method, apparatus, electronic device and storage medium for combat control are provided. The method comprising: determining, according to current game status data and communication information of the target object, a communicated strategic intention of a target object, wherein the communicated strategic intention characterizes a combat target expressed by the communication information; determining, according to the game status data, an initial strategic intention of a virtual object in response to the game state data; determining, according to the initial strategic intention and the communicated strategic intention, the target strategic intention of the virtual object; determining a response action of the virtual object based on the target strategic intention, and controlling the virtual object to perform the response action. In this way, the virtual object may have an ability to understand the communicated strategic intention of the virtual object and respond, improving an anthropomorphism and coordination ability of the virtual object.

### CROSS REFERENCE TO RELATED APPLICATIONS

The present application claims priority to Chinese Patent Application No. 202211252942.X, entitled “METHOD, APPARATUS, ELECTRONIC DEVICE AND STORAGE MEDIUM FOR COMBAT CONTROL,” filed on Oct. 13, 2022, the contents of which are hereby incorporated by reference in its entirety.

### TECHNICAL FIELD

The present disclosure relates to the field of computer technology, specifically to a method, apparatus, electronic device and storage medium for combat control.

### BACKGROUND

At present, artificial intelligence is widely used in various games. For example, in games, artificial intelligence can act as virtual characters and play games together as teammates of real players. However, in existing technology, artificial intelligence usually makes independent decisions in the game process, lacking the ability to respond to the strategic intentions of combat of humans, resulting in poor cooperation between artificial intelligence and real players, and also reduces the sense of participation of real players.

### SUMMARY

The present disclosure embodiment at least provides a method, apparatus, electronic device and storage medium for combat control.

In the first aspect, the present disclosure embodiment provides a method for combat control, comprising:
Determining, according to current game status data and communication information of the target object, a communicated strategic intention of a target object, wherein the communicated strategic intention characterizes a combat target expressed by the communication information;
Determining, according to the game status data, an initial strategic intention of a virtual object in response to the game state data;
Determining, according to the initial strategic intention and the communicated strategic intention, the target strategic intention of the virtual object;
Determining a response action of the virtual object based on the target strategic intention, and controlling the virtual object to perform the response action.

In an optional implementation, determining an initial strategic intention of a virtual object in response to the game status data according to the game status data comprises:
Inputting the game status data and the communicated strategic intention into a pre-trained strategy model, to obtain the initial strategic intention of the virtual object in response to the game status data;
Determining a response action of the virtual object based on the target strategic intention comprises:
Performing an action decision according to the target strategic intention and the game status data, to obtain a response action of the virtual object.

In an optional implementation, determining a target strategic intention of the virtual object according to the communicated strategic intention and the initial strategic intention comprises:
Identifying the communicated strategic intention based on the strategy model, to obtain a response probability for the communicated strategic intention;
If the response probability is greater than or equal to a preset threshold, determining a target strategic intention of the virtual object according to the communicated strategic intention.

In an optional implementation, determining a target strategic intention of the virtual object according to the communicated strategic intention and the initial strategic intention comprises:
Identifying the communicated strategic intention based on the strategy model, to obtain a response probability for the communicated strategic intention;
If the response probability is less than a preset threshold, determining the initial strategic intention as the target strategic intention of the virtual object.

In an optional implementation, further comprising training the strategy model by:
Obtaining game combat data;
Obtaining a training sample set according to the game combat data, wherein the training sample set comprises a plurality of first training samples, each first training sample at least comprising a first game status data sample and a strategic intention label and an action label in response to the first game status data sample;
Training the strategy model based on the training sample set, to obtain a trained strategy model;
Wherein training the strategy model based on the training sample set to obtain a trained strategy model comprises:
Inputting a first game status data sample of the training sample set into the strategy model to obtain a predicted strategic intention in response to the first game status data sample;
Obtaining a corresponding predicted response action, according to the first game status data sample and the predicted strategic intention or the strategic intention label, and training the strategy model according to the predicted strategic intention, the predicted response action and the strategic intention label and action label in the first training sample, until a target loss function of the strategy model is minimized;
Wherein the target loss function comprises a first loss function and a second loss function, the first loss function is a loss function between the predicted strategic intention and the strategic intention label, and the second loss function is a loss function between the predicted response action and the action label.

In an optional implementation, the determining a communicated strategic intention of a target object according to a current game status data and communication information of the target object comprises:
Inputting the game status data and the communication information of the target object into a pre-trained intention prediction model to obtain a communicated target strategic intention of the target object; wherein, the intention prediction model is trained with a plurality of second training samples, each second training sample comprising a second game status data sample, a communication information sample, and a communicated strategic intention label.

In an optional implementation, the communication information comprises at least one of the following: inputted text or audio information, signal information inputted for a shortcut communication control, and preset communication information corresponding to a specified behavior;
The game status data characterizing game related description information, comprising at least one of the following: game description information of the target object, game description information of the virtual object, and game environment description information.

In an optional implementation, determining the communication target strategic intention of the target object according to a current game status data and communication information of the target object comprises:
During a game combat, determining the communicated strategic intention of the target object according to a current game status data and communication information of the target object, wherein the game combat at least comprises an own team and an enemy team, the own team comprising one or more target objects and one or more virtual objects, and the enemy team comprising a plurality of game objects.

In an optional implementation, determining a communicated strategic intention of the target object according to a current game status data and communication information of the target object comprises: when the communication information of a plurality of target objects is obtained during the game combat, determining a communicated strategic intention of each target object respectively;
Determining a target strategic intention of the virtual object according to the initial strategic intention and the communicated strategic intention comprises: determining a target strategic intention of the virtual object for each target object according to the initial strategic intention and the communicated strategic intention of each target object;
Determining a response action of the virtual object based on the target strategic intention and controlling the virtual object to perform the response action, comprises: determining, according to a preset rule, the response action of the virtual object based on a target strategic intention of the virtual object for each target object respectively, and controlling the virtual object to perform a response action for each target object respectively.

In the second aspect, the present disclosure embodiment provides a device for combat control, comprising:
A first determination module, configured to determining, according to current game status data and communication information of the target object, a communicated strategic intention of a target object, wherein the communicated strategic intention characterizes a combat target expressed by the communication information;
A second determination module, configured to determining, according to the game status data, an initial strategic intention of a virtual object in response to the game state data;
A third determination module, configured to determining, according to the initial strategic intention and the communicated strategic intention, the target strategic intention of the virtual object;
A fourth determination module, configured to determining a response action of the virtual object based on the target strategic intention;
A control module, configured to controlling the virtual object to perform the response action.

In the third aspect, the present disclosure optional embodiment further provide an electronic device, comprising: one or more processors; one or more memories coupled to the one or more processors and having computer-executable instructions stored thereon, the computer-executable instructions, when executed by the one or more processors, causing the device to perform the steps in the above-mentioned first aspect or any possible implementation of the first aspect.

In the fourth aspect, the present disclosure optional embodiment further provide a computer readable storage medium having computer-executable instructions stored thereon, the computer-executable instructions, when executed by a processor, causing the processor to perform the steps in the above-mentioned first aspect or any possible implementation of the first aspect.

In the present disclosure embodiment, determining, according to current game status data and communication information of the target object, a communicated strategic intention of a target object, wherein the communicated strategic intention characterizes a combat target expressed by the communication information; determining, according to the game status data, an initial strategic intention of a virtual object in response to the game state data; determining, according to the initial strategic intention and the communicated strategic intention, the target strategic intention of the virtual object; determining a response action of the virtual object based on the target strategic intention, and controlling the virtual object to perform the response action. In this way, determining the communicated strategic intention of a target object and the initial strategic intention of a virtual object, judging the initial strategic intention and communication strategic intention, determining the final target strategic intention and response action of the virtual object, enabling virtual object to understand and respond to the communication strategic intentions of the target object, improving the anthropomorphism of the virtual object and its ability to cooperate with the target object, and further promoting the willingness of the target object to actively communicate, further improving the game experience and game quality.

For the description of the effects of the aforementioned combat control apparatus, electronic device, and computer-readable storage media, please refer to the description of the combat control methods mentioned above, which will not be repeated here.

In order to make the above purposes, features, and advantages of the present disclosure more apparent and understandable, the following text provides preferred embodiments, and in conjunction with the accompanying drawings, provides a detailed explanation as follows.

### BRIEF DESCRIPTION OF DRAWINGS

In order to provide a clearer explanation of the technical solution of the present disclosure embodiments, a brief introduction will be given to the accompanying drawings required in the embodiments. The accompanying drawings are incorporated into the specification and form a part of the specification. These drawings illustrate embodiments that comply with the present disclosure and are used together with the specification to illustrate the technical solution of the present disclosure. It should be understood that the following drawings only illustrate certain embodiments of the present disclosure, and therefore should not be regarded as limiting the scope. For ordinary technical personnel in the art, other relevant drawings can also be obtained based on these drawings without creative labor.

FIG. 1 shows a flowchart of a combat control method provided for an embodiment of the present disclosure;

FIG. 2 shows a training method flowchart of the strategy model provided for an embodiment of the present disclosure;

FIG. 3 shows a flowchart of another combat control method provided for an embodiment of the present disclosure;

FIG. 4 shows a schematic diagram of an combat control device provided for an embodiment of the present disclosure;

FIG. 5 shows a schematic diagram of an electronic device provided for an embodiment of the present disclosure.

### DETAILED DESCRIPTIONS

It can be understood that before using the technical solutions disclosed in each embodiment of the present disclosure, users should be informed of the type, scope of use, usage scenarios, etc. of personal information involved in the present disclosure in accordance with relevant laws and regulations in an appropriate manner and obtain authorization from the users.

In order to make the purpose, technical solution, and advantages of the present disclosure embodiments clearer, the following will provide a clear and complete description of the technical solution in the present disclosure embodiments in conjunction with the accompanying drawings. Obviously, the described embodiments are only a part of the present disclosure embodiments, not all of them. The components of the present disclosure embodiments typically described and shown here can be arranged and designed in various different configurations. Therefore, the following detailed description of the embodiments of the present disclosure is not intended to limit the scope of the claimed protection, but only to represent the selected embodiments of the present disclosure. Based on the present disclosure embodiments, all other embodiments obtained by those skilled in the art without creative labor fall within the scope of protection of the present disclosure.

Through research, it has been found that artificial intelligence (AI) is currently widely used in various games. For example, in games, AI can act as virtual characters and play games together as teammates of real players. However, in existing technology, AI is usually independent decisions and lacks the ability to respond to the strategic intentions of combat of humans, As a result, the cooperation between artificial intelligence and real players is poor, and the sense of participation of real players is reduced. Therefore, how artificial intelligence can understand the strategic intentions of real players and respond is currently a difficult and urgent problem to be solved.

Based on the above research, the present disclosure provides a method for combat control, determining, according to current game status data and communication information of the target object, a communicated strategic intention of a target object, determining, according to the game status data, an initial strategic intention of a virtual object in response to the game state data, and determining, according to the initial strategic intention and the communicated strategic intention, the target strategic intention of the virtual object, and then determining a response action of the virtual object based on the target strategic intention, and controlling the virtual object to perform the response action. In this way, by exchanging information, the communication target strategic intention of a target object can be understood, and combined with the communication strategic intention to determine the final response action of the virtual object, enabling the virtual object have the ability to understand and respond to the strategic intention of the target object, this can further enhance the game coordination ability between the virtual object and the target object, enhance the game participation and experience of the target object, and also enhance the game teammate attributes of the virtual object.

The shortcomings of the above solutions are all the results of the inventor's practice and careful study. Therefore, the discovery process of the above problems and the solutions proposed by the present disclosure in the following text should all be the contributions made by the inventor to the present disclosure process.

It should be noted that similar label and letter represent similar terms in the following figures, so once an item is defined in a figure, further definition and explanation are not required in subsequent figures.

For the convenience the understanding of the present embodiment, a detailed introduction is given to a combat control method disclosed in the present disclosure embodiment. The executing entity of the combat control method provided in the present disclosure embodiment is generally an electronic device with certain computing power. The electronic device comprises, for example, terminal devices or servers or other processing devices, which can be User Equipment (UE), mobile devices, Personal Digital Assistants (PDA), handheld devices, computing devices, in vehicle devices, wearable devices, etc. The Personal Digital Assistants is a handheld electronic device that has certain functions of an electronic computer, it can be used to manage personal information, browse the internet, send and receive emails, etc. It is generally not equipped with a keyboard and can also be called a handheld computer. In some possible implementations, the combat control method can be implemented by the processor calling computer-readable instructions stored in memory.

It should be noted that the present disclosure embodiment provides the combat control method can be applied to any game scenes that interactively controls virtual objects. For example, it can comprise third person perspective shooting games, first person perspective shooting games, role playing games, action games, strategy games, combat games, sports competitive games, adventure games, etc., all of which can adopt the combat control methods provided by the embodiments of the present disclosure, without specific limited herein.

In the present disclosure embodiment, the game operation interface is also a page displaying game scenes: comprise virtual objects in the game scene; virtual objects can comprise but are not limited to virtual characters controlled by players, and Non-Player Characters (NPC); In the present disclosure embodiment, for the convenience of description and differentiation, the situations of artificial intelligence and real player control in game scenes are described as virtual objects and target objects, respectively. Virtual characters can comprises but are not limited to, at least one of virtual characters and virtual animals, virtual characters that can be controlled by players, and non-player characters, which are set according to the needs of the game, and are not specifically limited here; the general game operation interface comprises a plurality of buttons that can be touched by the player, the player can controls the virtual object to perform corresponding operations through the touch buttons. For example, when the game comprises shooting games, the game operation interface can comprise various types of buttons such as item usage buttons, movement buttons (such as a joystick), action buttons (such as aiming, jumping, squatting, crawling, etc.) and attack buttons (such as skill release, shooting, etc.).

The communication control method provided in the present disclosure embodiment will be explained using the execution subject as the server as an example.

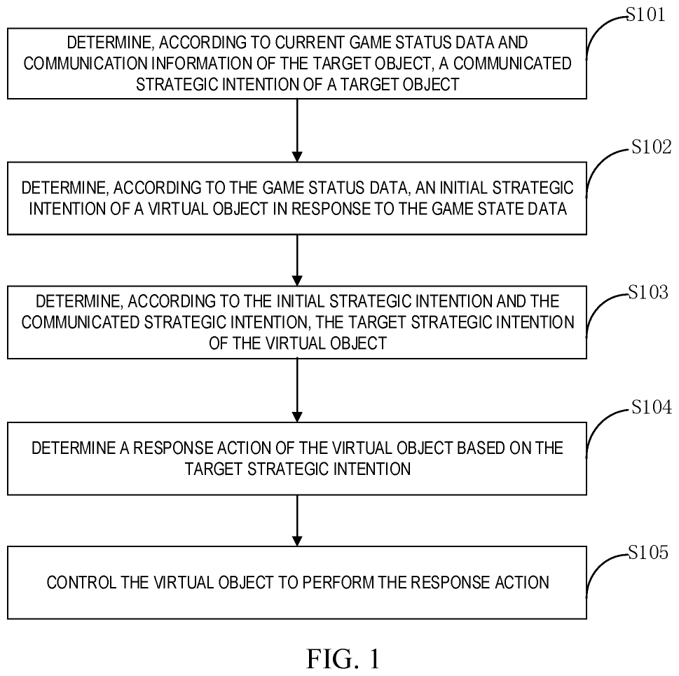

As shown in FIG. 1, a flowchart of a combat control method provided in the present disclosure embodiment, the method comprises:
S101: Determining, according to current game status data and communication information of the target object, a communicated strategic intention of a target object.

Wherein, the game status data characterizing game related description information, comprises at least one of the following: game description information of the target object, game description information of the virtual object, and game environment description information.

For example, the game description information of the target object or virtual object represents one's own game status, game behavior, and other information, which can comprise one's own health, mana, economy, kill, assist, death count, and so on; the game environment description information can comprise the survival status of wild monsters, obstacles, etc.

Communication information refers to the relevant information used for communication, which comprises at least one of the following: input text or voice information, signal information input for quick communication controls, and preset communication information corresponding to the specified behavior.

In the present disclosure embodiment, players can communicate and exchange information in real-time during game combats, and can output communication information in different ways. For example, text or voice information can be input through input boxes; in the game operation interface, there are quick communication controls for sending signals, such as attacking, gathering, retreating, etc. By clicking on this quick communication control, you can quickly input the desired communication information; and in the present disclosure embodiment, communication information expressed can also be set corresponding to different specified behaviors. In this way, during the current game combat, if there is no target object speaking, if a target object has a specified behavior, such as executing a tower pushing behavior, it can be considered that communication information has been triggered. At this time, a communication information corresponding to the tower pushing behavior can be generated by default, For example, if the corresponding communication information is “Come quickly for support”, the communication strategic intention of target object can also be determined based on the communication information, and the virtual object of AI can respond to the communication strategic intention.

In addition, in the present disclosure embodiment, there is no restriction on the output method of communication information, and it can also comprise emoticons, shortcut words, etc.

The communication strategic intention characterizes the combat objectives expressed by the communication information, and in the present disclosure embodiment, the communication strategic intention is also related to the current game state data, such as the area that wants to attack or defend, the strategic points and strategic resources that want to attack or defend, etc.

In the present disclosure embodiment, it mainly targets multiplayer game scenes where artificial intelligence can cooperate with live players in combat. For example, in a possible embodiment, the game combat comprises at least one own team and an enemy team, with one or more target objects and one or more virtual objects comprised in the team. The enemy team comprises a plurality of game objects, where the target object, for example, is a live player, Virtual objects, such as artificial intelligence, are not limited to the number of real players and artificial intelligence within the same team. For example, in a 5V5 game, a team of five can have four real players and one artificial intelligence.

In the present disclosure embodiment, step S101 can be executed during the game combat, that is, during step S101 can be executed, a possible embodiment is to determine the communication strategy intention of the target object based on the current game state data and communication information of the target object during the game combat.

Moreover, in the present disclosure embodiment, step S101 can be implemented based on an intention prediction model, which comprises: inputting game state data and communication information of the target object into a pre trained intention prediction model to obtain the communication strategy intention of the target object; Wherein, the intention prediction model is trained based on a plurality of second training samples, each of which comprises second game state data samples, communication information samples, and communication strategy intention label.

Wherein, the second training sample can be obtained based on the game data of real players. For example, to obtain game data of a plurality of real players, in order to further improve reliability, the game data can be filtered to select the game data of high reliability real players. Then, based on the game data, the communication information and corresponding game status data of real players can be extracted from the game data, and based on the behavior and game status data of the real player before and after sending communication information, the communication strategy intention can be determined, which can be analyzed manually or determined based on other methods without limited herein. In this way, a second training sample can be obtained based on the extracted communication information, corresponding game status data, and communication strategy intention.
S102: Determining, according to the game status data, an initial strategic intention of a virtual object in response to the game state data.

In the present disclosed embodiment, the virtual object, for example, is an artificial intelligence that engages in combat competition in a game. During the action decision process of the virtual object, the initial strategic intention of the virtual object is displayed and defined. Specifically, when performing step S102, it comprises inputting game state data and communication strategic intention into a pre trained strategy model to obtain the initial strategic intention of the virtual object in response to game state data.

In this way, by defining and displaying the modeled initial strategic intention, the strategy model can be guided to effectively output the initial strategic intention during wartime, thereby facilitating the understanding and response of the communication strategic intention of the target object in the future.
S103: Determining, according to the initial strategic intention and the communicated strategic intention, the target strategic intention of the virtual object.

In the present disclosure embodiment, when performing step S103, the following possible implementation methods can be comprised:
The first implementation method: 1) Based on the strategy model, identify the communication strategic intention and obtain the response probability for the communication strategic intention.

In the present disclosure embodiment, by comparing the initial strategic intention predicted based on the strategy model with the communication strategic intention of target object through the strategy model, the response probability for the initial strategic intention and the communication strategic intention can be determined, and the final target strategic intention can be comprehensively predicted.
2) if the response probability is greater than or equal to a preset threshold, determining a target strategic intention of the virtual object according to the communicated strategic intention.

Wherein, the preset threshold can be set according to actual experience or determined by decision model through training and learning, and is not limited in the present disclosure embodiment.

When the response probability to the communication strategic intention is greater than or equal to a certain threshold, it can be considered necessary to respond to the communication strategic intention, and the final target strategic intention can be determined based on the communication strategic intention. For example, the communication strategic intention can be directly used as the virtual target strategic intention, or, for example, based on the communication strategic intention, determine a strategic intention that is closer to or similar to the communication strategic intention, but easier to understand, as the target strategic intention of the virtual object. For example, based on the communication strategic intention, a strategic intention that matches the communication strategic intention can be determined as the target strategic intention of the virtual object, without limited herein.
The second implementation method: 1) based on the strategy model, identify the communication strategic intention and obtain the response probability for the communication strategic intention.
2) if the response probability is less than the preset threshold, the initial strategic intention is determined as the target strategic intention of the virtual object.

If the response probability to the communication strategic intention is less than the preset threshold, it can be considered that there is no need to respond to the communication strategic intention of the target object. At this time, the initial strategic intention predicted by the strategy model will still be used as the final target strategic intention of the virtual object.

In addition, in the present disclosure embodiment, during the comparison process between communication strategic intention and initial strategic intention, the strategy model can also identify the flag bits of communication strategic intention to determine what the final target strategic intention is. For example, if the value of the flag bits of communication strategic intention is 0, it indicates that there is no need to respond to the communication strategic intention, and the initial strategic intention can be used as the target strategic intention, for example, if the value of the flag bit for communication strategic intention is 1, it indicates the need to respond to the communication strategic intention. At this time, the target strategic intention can be determined based on the communication strategic intention.

Wherein, the process of identifying the flag bits of communication strategic intention can also be understood as the process of identifying the response probability of communication strategic intention. The response probability is greater than or equal to the preset threshold, the value of the flag bits is 1, the response probability is less than the preset threshold, and the value of the flag bits is 0.

In this way, in the present disclosure embodiment, the communication strategic intention of the target object is input into the decision model, and the understanding and response of the virtual object to the communication strategic intention of the target object is achieved by influencing the initial strategic intention in the decision model, and it is not completely consistent with the communication strategic intention of the target object. The strategic model also compares the communication strategic intention with its predicted the initial communication strategic intention, identifying the ultimate goal strategic intention can improve the rationality of the goal strategic intention and the prediction of subsequent response actions, which is more in line with the current game state data, making virtual objects more anthropomorphic and realistic, not blindly following the target object, but also improving game coordination and gaming experience.
S104: Determining a response action of the virtual object based on the target strategic intention.

When executing step S104, it comprises performing an action decision according to the target strategic intention and the game status data, to obtain a response action of the virtual object.

In the present disclosure embodiment, during the response action decision process through the decision model the initial strategic intention predicted by the decision model is displayed and modeled, and then the communication strategic intention of the target object is obtained, the communication strategic intention is compared with the initial strategic intention, the final target strategic intention is determined, and the action decision is made based on the target strategic intention and game state data to obtain the final response action. In this way, it not only improves the action prediction effect of the decision model, but also can better understand the communication strategic intention of the target object and take more reasonable and correct response behavior.
S105: controlling the virtual object to perform the response action.

It should be noted that in the present disclosure embodiment, the above step S101 can be achieved through the intention prediction model, and the above steps S102-S104 are achieved through the strategy model, the intention prediction model and the strategy model can be trained independently during training, after training is completed, the communication strategic intention of the target object output by the intention prediction model is input into the decision model in practical application, the response effect of the virtual object can be achieved by influencing the initial strategic intention in the decision model, which endows the virtual object with the ability to understand and respond to the communication strategic intention of the target object.

Furthermore, in the present disclosed embodiment, it is possible to target a game scenes where a plurality of players is involved in the team of both parties involved in the combat. Players from the same team can communicate and communicate to better cooperate in the combat, and there may be a plurality of target objects outputting communication information. In this case, the virtual objects of AI can respond to the communication strategic intentions of each target object separately. Specifically, in the present disclosure embodiment, in the case of a plurality of target objects outputting communication information, possible implementation methods are also provided:
Based on the current game status data and the communication information of the target object, determine the communication strategic intention of the target object, comprising: during game combats, when obtaining communication information from a plurality of target objects, determine the communication strategic intention of each target object separately.

For example, if a plurality of target objects currently output communication information, the communication strategic intentions of each target object can be determined separately.
2) Determine the target strategic intention of the virtual object based on the initial strategic intention and communication strategic intention, comprising determining the target strategic intention of the virtual object for each target object based on the initial strategic intention and communication strategic intention of each target object.

In the present disclosure embodiment, based on the current game state data, the initial strategic intention of the virtual object is determined. Due to different response actions or actions executed by different target objects at different times or based on the output of the virtual object, the game state data will also change. Therefore, when the virtual object responds to the communication strategic intention of each target object, after controlling the virtual object to perform a response action against a certain target object, the current game state data can be obtained to calculate the current initial strategic intention, and then determine the target strategic intention and response action against another target object. This can improve the accuracy and rationality of the response action.
3) Based on the target strategic intention, determine the response actions of the virtual object and control the virtual object to execute the response actions, comprises: according to preset rule, determine the response actions of the virtual object to each target object based on the target strategic intention of the virtual object, and control the virtual object to execute the response actions for each target object.

Wherein, preset rule can be set based on needs and experience, and there are not limited in the present disclosure embodiment. For example, the preset rule can be to respond to each target object respectively in the order of the time before and after in which the communication information output of by the target object, that is, the target strategic intention and response action can be determined for the communication information of the target object that comes first, and the virtual object can be controlled to execute response action for the target object, and then respond to the communication strategic intention of the next target object; for another example, the preset rule can be to respond separately according to the priority of the target object, giving priority to the communication strategic intention of the target object with higher priority, wherein, the priority of the target object can be determined according to the position attribute of the target object, for example the priority of the target object whose position is captain is higher, or the priority of the target object can also be determined according to the game level or win-loss rate of the target object, the higher the game level or winning rate, the higher the priority can be considered.

In the present disclosure embodiment, determining, according to current game status data and communication information of the target object, a communicated strategic intention of a target object, determining, according to the game status data, an initial strategic intention of a virtual object in response to the game state data, determining, according to the initial strategic intention and the communicated strategic intention, the target strategic intention of the virtual object, and then determining a response action of the virtual object based on the target strategic intention, and controlling the virtual object to perform the response action. In this way, by identifying and judging the initial strategic intention of the virtual object and the communication strategic intention of the target object, the final target strategic intention of the virtual object can be determined, and the response actions of the virtual object can be controlled, so that the virtual object can understand the communication strategic intention of the target object and respond, improve the cooperation ability of the virtual object and the target object, and also make the virtual object have higher anthropomorphism and the ability to cooperate with real players, thereby promoting the player's communication desire, the virtual object can respond to the communication strategic intention of the target object, it will make the target audience more willing to actively communicate and further improve the game experience and game combat quality.

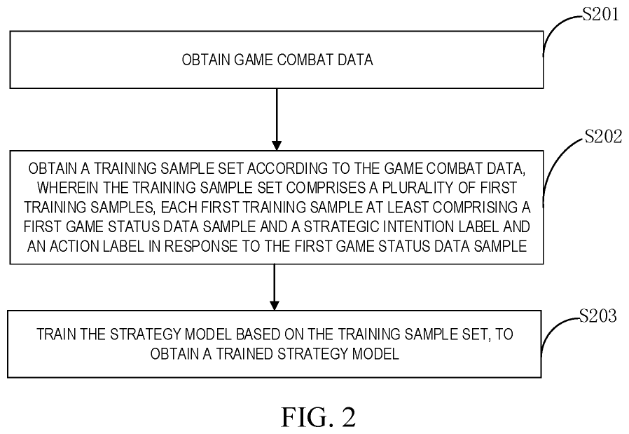

Based on the above embodiments, the training method of the strategy model in the present disclosure embodiment will be explained below. As shown in FIG. 2, it is a flowchart of the training method for the strategy model in the present disclosure embodiment, which comprises:
S201: Obtaining game combat data.
S202: According to game combat data, obtain a training sample set, which comprises a plurality of first training samples, each first training sample comprises at least the first game state data sample, and a strategic intention label and action label responsive to the first game state data sample.

In the present disclosed embodiment, game combat data of a plurality of objects can be obtained, for example, for a certain object A, during the game combat process of a certain game, the actions and strategic intentions performed by object A under different game state data are extracted, usually, the actions performed by object A on the game state data are consistent with its strategic intentions, so the corresponding strategic intentions can be determined based on the actions performed, it can be determined through manual analysis or through other methods, without limited herein, the actions performed by object A for a certain game state data can be used as action label, and the corresponding strategic intention can be used as strategic intention label, and then obtain a plurality of first training samples of object A can be obtained, based on this method, first training samples of a plurality of objects can be obtained.

Further, in order to improve the reliability and accuracy of strategy model training, the first training sample can be screened and filtered by preset reliability indicators, and the first training sample of the object with higher reliability can be selected.
S203: Based on the training sample set, train the strategy model to obtain the trained strategy model.

Specifically execute step S203, the present disclosure provides a possible implementation method:
Input the first game state data sample in the training sample set into the strategy model to obtain the predicted strategic intention in response to the first game state data sample.

In the present disclosure embodiment, during the training process, the first game state data sample of the first training sample is input into the strategy model, and the first game state data is identified through the strategy model to obtain the predicted strategic intention, this process, the strategic intention label in the first training sample is used as the learning target, that is, the first Loss function is calculated based on the predicted strategic intention and the strategic intention label.
2) According to the first game state data sample, and the predicted strategic intention or strategic intention label, the corresponding predicted response action is obtained, and according to the predicted strategic intention and predicted response action, and the strategic intention label and action label in the first training sample, the strategy model is trained until the target loss function of the strategy model is the minimized.

Wherein, the target Loss function comprises the first Loss function and the second Loss function, the first Loss function is the Loss function between the predicted strategic intention and the strategic intention label, and the second Loss function is the Loss function between the predicted response action and the action label.

In the present disclosure embodiment, in the process of strategy model training, after obtaining the predicted strategic intention, the identification of the predicted response action is performed. This process uses the action label in the first training sample as the learning target, corresponding to the second Loss function. However, this process does not just use the strategic intention label in the first training sample for training, but also mixes the predicted strategic intention determined by the strategy model, that is, in this process, the first game state data sample can be used and predicted response actions, perform identification to obtain predicted response actions, or perform identification based on the first game state data sample and strategic intention label to obtain predicted response actions, mixed training of predict strategic intentions and strategic intention label based on the first training sample in the training sample set, and in order to make a strategy model better distinguish these two states, This can be achieved by constructing flag bit in the strategy model, for example, the value of the flag bit corresponding to the strategic intention label is determined to be 1, indicating the need to respond to the strategic intention label, and determining the value of the flag bit corresponding to the predicted strategic intention as 0, indicating that there is no need to respond to the predicted strategic intention, thereby enabling the strategy model to learn what kind of strategic intention should respond, and what kind of strategic intention does not require responded, and the mixing ratio can also be controlled based on the flag bit.

And, in the training process of the strategy model, the mixing ratio of the first training sample for predicting strategic intention and strategic intention label is not limited, the mixing ratio can be determined by actual verification results or experience, for example, the proportion of the first training sample for predicting response action identification based on strategic intention label can be 60%.

That is to say, in the present disclosure embodiment, the training process of the strategy model can be understood as comprising two stages, the input of the first stage is the first game state data sample of the first training sample, the output is the predicted strategic intention, the Loss function of the first stage is the first Loss function, and the learning target is the strategic intention label; the input of the second stage is the first game state data sample and the strategic intention label of the first training sample, or the first game state data sample and the predicted strategic intention of the first training sample, the output is the predicted response action, the Loss function of the second stage is the second Loss function, the learning is the action label, the first stage and the second stage are a complete training process.

In this way, in the present disclosure embodiment, in the second stage of strategy model training, mixed training of predicted strategic intention and strategic intention label can enable the strategy model to have the ability to determine whether it responds to a certain strategic intention, and then the training is completed the resulting strategy model can not only have the ability to respond to the communication strategic intention of the target object, but also have its own independent judgment ability, based on the communication strategic intention of reasonable target objects, through the judgment of the strategy model, the virtual object can choose to respond, update the original initial strategic intention of the strategy model is used to implement corresponding response actions in response to the communication strategic intention, however, for the communication strategic intention of some unreasonable target objects, through the judgment of the strategy model, the virtual object can choose to ignore and use the initial strategic intention to determine the response action, thereby making virtual objects more anthropomorphic, the respond action more accurate and reasonable, and improving the gaming experience.

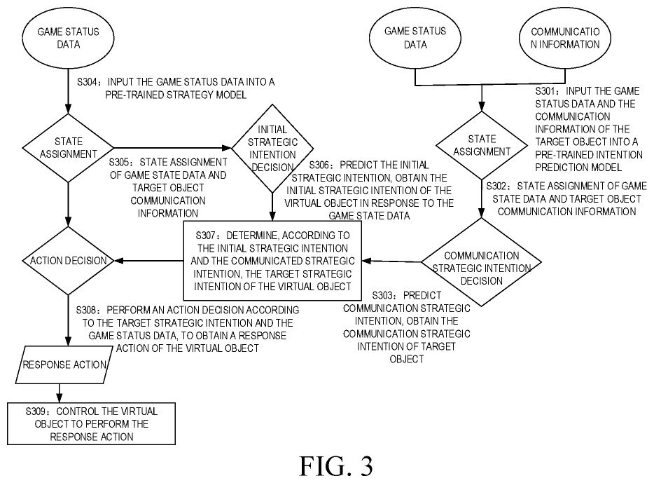

The following is a brief explanation of the combat control method in the present disclosure embodiment using specific application scenarios, as shown in FIG. 3, which is a flowchart of another combat control method in the present disclosure embodiment, comprising:
S301: Input game state data and communication information of the target object into a pre trained intention prediction model.
S302: state assignment the game status data and communication information of the target object.
S303: Conduct communication strategic intention prediction to obtain the communication target strategic intention audience.

The above steps S301-S303 are implemented through an intention prediction model.
S304: Input game state data into a pre trained strategy model.
S305: state assignment game state data and communication information of target objects for state encoding.
S306: Predict the initial strategic intention prediction, obtain the virtual object in response to the initial strategic intention of game state data.
S307: Determine the target strategic intention of the virtual object based on the initial strategic intention and communication strategic intention.

That is, the communication strategic intention output by the intention prediction model is also input into the strategy model, the strategy model judges the initial strategic intention and the communication strategic intention to determine the final target strategic intention.
S308: Based on the target strategic intention and game state data, make action decisions to obtain the response actions of the virtual object.

The above steps S304-S308 are implemented through a strategy model.
S309: Control virtual objects to perform response actions.

It should be noted that the specific execution methods of each of the above steps is the same as the execution methods in the above embodiments, so we will not elaborate on them here.

In this way, in the present disclosure embodiment, by defining strategic intentions and displaying modeling, guiding the strategy model to obtain the initial strategic intentions of the virtual object while performing an action decisions, and obtaining the communication strategic intentions of the target object through the intention prediction model, and then inputting the communication strategic intentions of the target object into the strategy model, the virtual object can understand and respond to the communication strategic intentions of the target object, Improve the coordination ability between virtual objects and target objects, and improving the gaming experience.

Those skilled in the art can understand that in the specific implementation methods mentioned above, the writing order of each step does not imply a strict execution order and imposes any limitations on the implementation process. The specific execution order of each step should be determined based on its function and possible internal logic.

Based on the same inventive concept, the present disclosed embodiment further provide a combat control device corresponding to the combat control method. As the principle of solving the problem in the combat control device in the present disclosed embodiment is similar to the aforementioned combat control method in the present disclosed embodiment, the implementation of the combat control device can be referred to in the implementation of the combat control method, and any repetition will not be elaborated.

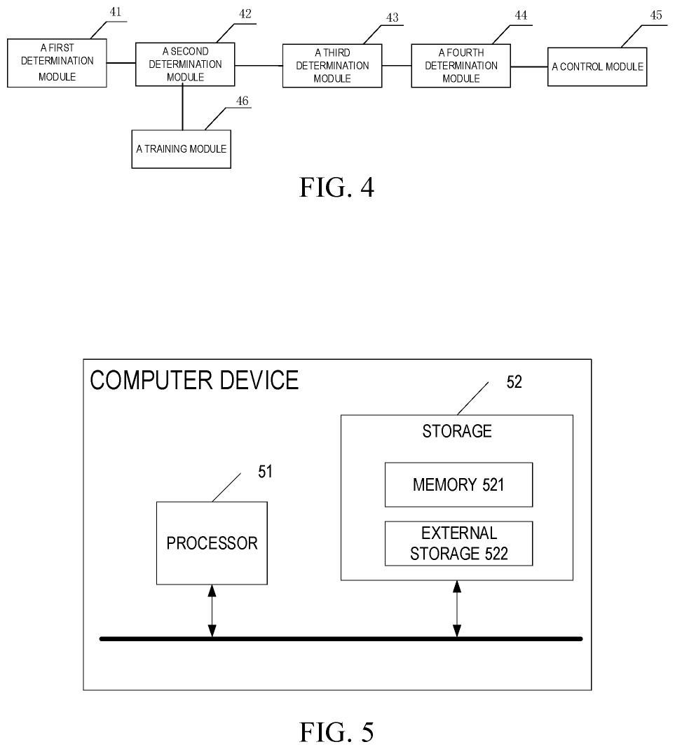

As shown in FIG. 4, a schematic diagram of a combat control device provided by an embodiment of the present disclosure, the device comprises:

The first determination module 41, for determining, according to current game status data and communication information of the target object, a communicated strategic intention of a target object, wherein the communicated strategic intention characterizes a combat target expressed by the communication information;
The second determination module 42, for determining, according to the game status data, an initial strategic intention of a virtual object in response to the game state data;
The third determination module 43, for determining, according to the initial strategic intention and the communicated strategic intention, the target strategic intention of the virtual object;
The fourth determination module 44, for determining a response action of the virtual object based on the target strategic intention;
A control module 45, for controlling the virtual object to perform the response action.

In an optional implementation, when determining an initial strategic intention of a virtual object in response to the game status data according to the game status data, the second determination module 42 is configured to:
Inputting the game status data and the communicated strategic intention into a pre-trained strategy model, to obtain the initial strategic intention of the virtual object in response to the game status data;
When determining a response action of the virtual object based on the target strategic intention, the fourth determination module 44 is configured to:
Performing an action decision according to the target strategic intention and the game status data, to obtain a response action of the virtual object.

In an optional implementation, when determining a target strategic intention of the virtual object according to the communicated strategic intention and the initial strategic intention, the third determination module 43 is configured to:
Identifying the communicated strategic intention based on the strategy model, to obtain a response probability for the communicated strategic intention;
if the response probability is greater than or equal to a preset threshold, determining a target strategic intention of the virtual object according to the communicated strategic intention.

In an optional implementation, when determining a target strategic intention of the virtual object according to the communicated strategic intention and the initial strategic intention, the third determination module 43 is configured to:
Identifying the communicated strategic intention based on the strategy model, to obtain a response probability for the communicated strategic intention;
If the response probability is less than a preset threshold, determining the initial strategic intention as the target strategic intention of the virtual object.

In an optional implementation, further comprises training module 46, which is configured to:
Obtaining game combat data;
Obtaining a training sample set according to the game combat data, wherein the training sample set comprises a plurality of first training samples, each first training sample at least comprising a first game status data sample and a strategic intention label and an action label in response to the first game status data sample;
Training the strategy model based on the training sample set, to obtain a trained strategy model;
wherein training the strategy model based on the training sample set to obtain a trained strategy model, the training module 46 is configured to:
Inputting a first game status data sample of the training sample set into the strategy model to obtain a predicted strategic intention in response to the first game status data sample;
Obtaining a corresponding predicted response action, according to the first game status data sample and the predicted strategic intention or the strategic intention tag, and training the strategy model according to the predicted strategic intention, the predicted response action and the strategic intention tag and action tag in the first training sample, until a target loss function of the strategy model is minimized;
Wherein the target loss function comprises a first loss function and a second loss function, the first loss function is a loss function between the predicted strategic intention and the strategic intention label, and the second loss function is a loss function between the predicted response action and the action label.

In an optional implementation, when the determining a communicated strategic intention of a target object according to a current game status data and communication information of the target object, the first determination module 41 is configured to:
Inputting the game status data and the communication information of the target object into a pre-trained intention prediction model to obtain a communicated target strategic intention of the target object; wherein, the intention prediction model is trained with a plurality of second training samples, each second training sample comprising a second game status data sample, a communication information sample, and a communicated strategic intention label.

In an optional implementation, the communication information comprises at least one of the following: inputted text or audio information, signal information inputted for a shortcut communication control, and preset communication information corresponding to a specified behavior;
The game status data characterizing game related description information, comprising at least one of the following: game description information of the target object, game description information of the virtual object, and game environment description information.

In an optional implementation, when determining the communication target strategic intention of the target object according to a current game status data and communication information of the target object, the first determination module 41 is configured to:
During a game combat, determining the communicated strategic intention of the target object according to a current game status data and communication information of the target object, wherein the game combat at least comprises an own team and an enemy team, the own team comprising one or more target objects and one or more virtual objects, and the enemy team comprising a plurality of game objects.

In an optional implementation, when determining a communicated strategic intention of the target object according to a current game status data and communication information of the target object, the first determination module 41 is configured to: when the communication information of a plurality of target objects is obtained during the game combat, determining a communicated strategic intention of each target object respectively;
When determining a target strategic intention of the virtual object according to the initial strategic intention and the communicated strategic intention, the third determination module 43 is configured to: determining a target strategic intention of the virtual object for each target object according to the initial strategic intention and the communicated strategic intention of each target object;
Determining a response action of the virtual object based on the target strategic intention and controlling the virtual object to perform the response action, the fourth determination module 44 is configured to: determining, according to a preset rule, the response action of the virtual object based on a target strategic intention of the virtual object for each target object respectively, and control module 45 is configured to: controlling the virtual object to perform a response action for each target object respectively.

For a description of the processing flow of each module in the device, and the interaction flow between each module, please refer to the relevant instructions in the above method embodiments, and will not be described in detail herein.

The present disclosure embodiment further provide an electronic device, as shown in FIG. 5, which is a schematic diagram of the electronic device structure provided by the present disclosure embodiment, comprising:
Processor 51 and memory 52; The memory 52 stores machine readable instructions that can be executed by the processor 51, which is used to execute the machine readable instructions stored in the memory 52, when the machine readable instructions are executed by the processor 51, the processor 51 performs the following steps:
Determining, according to current game status data and communication information of the target object, a communicated strategic intention of a target object, wherein the communicated strategic intention characterizes a combat target expressed by the communication information;
Determining, according to the game status data, an initial strategic intention of a virtual object in response to the game state data;
Determining, according to the initial strategic intention and the communicated strategic intention, the target strategic intention of the virtual object;
Determining a response action of the virtual object based on the target strategic intention;
Controlling the virtual object to perform the response action.

In an optional implementation, when determining an initial strategic intention of a virtual object in response to the game status data according to the game status data, the processor 51 is configured to:
Inputting the game status data and the communicated strategic intention into a pre-trained strategy model, to obtain the initial strategic intention of the virtual object in response to the game status data;
When determining a response action of the virtual object based on the target strategic intention, the processor 51 is configured to:
performing an action decision according to the target strategic intention and the game status data, to obtain a response action of the virtual object.

In an optional implementation, when determining a target strategic intention of the virtual object according to the communicated strategic intention and the initial strategic intention, the processor 51 is configured to:
Identifying the communicated strategic intention based on the strategy model, to obtain a response probability for the communicated strategic intention;
If the response probability is greater than or equal to a preset threshold, determining a target strategic intention of the virtual object according to the communicated strategic intention.

In an optional implementation, when determining a target strategic intention of the virtual object according to the communicated strategic intention and the initial strategic intention, the processor 51 is configured to:
Identifying the communicated strategic intention based on the strategy model, to obtain a response probability for the communicated strategic intention;
If the response probability is less than a preset threshold, determining the initial strategic intention as the target strategic intention of the virtual object.

In an optional implementation, the processor 51 executes the training mode of the strategy model is configured to:
Obtaining game combat data;
Obtaining a training sample set according to the game combat data, wherein the training sample set comprises a plurality of first training samples, each first training sample at least comprising a first game status data sample and a strategic intention label and an action label in response to the first game status data sample;
Training the strategy model based on the training sample set, to obtain a trained strategy model;
Wherein training the strategy model based on the training sample set to obtain a trained strategy model, the processor 51 is configured to:
Inputting a first game status data sample of the training sample set into the strategy model to obtain a predicted strategic intention in response to the first game status data sample;
obtaining a corresponding predicted response action, according to the first game status data sample and the predicted strategic intention or the strategic intention tag, and training the strategy model according to the predicted strategic intention, the predicted response action and the strategic intention tag and action tag in the first training sample, until a target loss function of the strategy model is minimized;
wherein the target loss function comprises a first loss function and a second loss function, the first loss function is a loss function between the predicted strategic intention and the strategic intention label, and the second loss function is a loss function between the predicted response action and the action label.

In an optional implementation, when the determining a communicated strategic intention of a target object according to a current game status data and communication information of the target object, the processor 51 is configured to:
Inputting the game status data and the communication information of the target object into a pre-trained intention prediction model to obtain a communicated target strategic intention of the target object; wherein, the intention prediction model is trained with a plurality of second training samples, each second training sample comprising a second game status data sample, a communication information sample, and a communicated strategic intention label.

In an optional implementation, the communication information comprises at least one of the following: inputted text or audio information, signal information inputted for a shortcut communication control, and preset communication information corresponding to a specified behavior; the game status data characterizing game related description information, comprising at least one of the following: game description information of the target object, game description information of the virtual object, and game environment description information.

In an optional implementation, when determining the communication target strategic intention of the target object according to a current game status data and communication information of the target object, the processor 51 is configured to: during a game combat, determining the communicated strategic intention of the target object according to a current game status data and communication information of the target object, wherein the game combat at least comprises an own team and an enemy team, the own team comprising one or more target objects and one or more virtual objects, and the enemy team comprising a plurality of game objects.

In an optional implementation, when determining a communicated strategic intention of the target object according to a current game status data and communication information of the target object, the processor 51 is configured to: when the communication information of a plurality of target objects is obtained during the game combat, determining a communicated strategic intention of each target object respectively;
When determining a target strategic intention of the virtual object according to the initial strategic intention and the communicated strategic intention, the processor 51 is configured to: determining a target strategic intention of the virtual object for each target object according to the initial strategic intention and the communicated strategic intention of each target object;
Determining a response action of the virtual object based on the target strategic intention and controlling the virtual object to perform the response action, the processor 51 is configured to: determining, according to a preset rule, the response action of the virtual object based on a target strategic intention of the virtual object for each target object respectively, and controlling the virtual object to perform a response action for each target object respectively.

The above-mentioned memory 52 comprises memory 521 and external memory 522; The memory 521 here is also called internal memory, and is used to temporarily store the calculation data in the processor 51 and the data exchanged with the external memory 522 such as the hard disk. The processor 51 exchanges data with the external memory 522 through the memory 521.

The specific execution process of the above instructions can refer to the steps of the combat control method described in the present disclosure embodiment, and will not be repeated herein.

The present disclosed embodiment further provide a computer-readable storage medium storing a computer program to perform the steps of the order searching method, or the steps of the order searching method described in the aforementioned method embodiments when the computer program are executed by a processor. The storage medium may be a volatile or non-volatile computer readable storage medium.

The present disclosed embodiment further provide a computer program product. The computer program product carries program code. The instructions included in the program code can be used to execute the steps of the combat control method described in the above method embodiment. Specifically, please refer to the above method embodiment and will not be repeated herein.

wherein, the above-mentioned computer program product can be specifically implemented by hardware, software, or a combination. In an optional embodiment, the computer program product is specifically embodied as a computer storage medium, in another optional embodiment, the computer program product is specifically embodied as a software product, such as a Software Development Kit SDK, etc.

It will be clear to those skilled in the art that, for ease and brevity of description, the specific processes of operation of the systems and device described above may be referred to the corresponding processes in the preceding method embodiments and will not be repeated herein. In the several embodiments provided by the disclosure, it should be understood that the disclosed systems, devices and methods, can be implemented in other ways. The embodiments of the devices described above are merely schematic, for example, the division of the units described, which is only a logical functional division, can be divided in another way when actually implemented, and also, for example, multiple units or components can be combined or can be integrated into another system, or some features can be ignored, or not implemented. And the mutual coupling or direct coupling or communication connection shown or discussed can be indirect coupling or communication connection through some communication interface, device or unit, which can be electrical, mechanical or other forms.

The units illustrated as separate components may or may not be physically separate, and the components displayed as units may or may not be physical units, i.e., they may be located in one place or may be distributed to multiple network units. Some or all of these units may be selected according to practical needs to achieve the purpose of this embodiment solution. In addition, each functional unit in various embodiments of the disclosure may be integrated in a single processing unit, or the individual units may be physically present separately, or two or more units may be integrated in a single unit.

The described functionality, when implemented in the form of a software functional unit and sold or used as a separate product, may be stored in a processor-executable, non-volatile computer readable storage medium. It is understood that the technical solutions of the disclosure, or portions of the technical solutions, that essentially contribute to the prior art may be embodied in the form of a software product stored in a storage medium comprising a number of instructions to cause a computing device (which may be a personal computer, a server, or a network device, etc.) to perform all or some of the steps of the methods described in various embodiments of the disclosure. The aforementioned storage media includes: USB flash drives, removable hard drives, Read-Only Memory (ROM), Random Access Memory (RAM), disks, or CD-ROMs, and other media that can store program code.

Finally, it should be noted that the above embodiments are only specific embodiments of the disclosure to illustrate the technical solutions of the disclosure and not to limit the scope of protection of the disclosure, which is not limited thereto. Despite the detailed description of the disclosure with reference to the foregoing embodiments, it should be understood by those of ordinary skill in the art that any person skilled in the art may still modify or readily conceive of changes to the technical solutions described in the foregoing embodiments, or make equivalent substitutions for some of the technical features thereof, within the scope of the technology disclosed in the disclosure. These modifications, changes or replacements do not make the essence of the corresponding technical solutions out of the spirit and scope of the technical solutions of the embodiments of the disclosure, and shall all be covered by the scope of protection of the disclosure. Therefore, the scope of protection of the disclosure shall be stated to be subject to the scope of protection of the claims.

I/We claim:

1. A method for combat control, comprising:
determining, according to current game status data and communication information of the target object, a communicated strategic intention of a target object, wherein the communicated strategic intention characterizes a combat target expressed by the communication information;
determining, according to the game status data, an initial strategic intention of a virtual object in response to the game state data;
determining, according to the initial strategic intention and the communicated strategic intention, the target strategic intention of the virtual object;
determining a response action of the virtual object based on the target strategic intention, and controlling the virtual object to perform the response action.

2. The method according to claim 1, wherein determining an initial strategic intention of a virtual object in response to the game status data according to the game status data comprises:
inputting the game status data and the communicated strategic intention into a pre-trained strategy model, to obtain the initial strategic intention of the virtual object in response to the game status data;
wherein determining a response action of the virtual object based on the target strategic intention comprises:
performing an action decision according to the target strategic intention and the game status data, to obtain a response action of the virtual object.

3. The method according to claim 2, wherein determining a target strategic intention of the virtual object according to the communicated strategic intention and the initial strategic intention comprises:
identifying the communicated strategic intention based on the strategy model, to obtain a response probability for the communicated strategic intention;
if the response probability is greater than or equal to a preset threshold, determining a target strategic intention of the virtual object according to the communicated strategic intention.

4. The method according to claim 2, wherein determining a target strategic intention of the virtual object according to the communicated strategic intention and the initial strategic intention comprises:
identifying the communicated strategic intention based on the strategy model, to obtain a response probability for the communicated strategic intention;
if the response probability is less than a preset threshold, determining the initial strategic intention as the target strategic intention of the virtual object.

5. The method according to claim 2, further comprising training the strategy model by:
obtaining game combat data;
obtaining a training sample set according to the game combat data, wherein the training sample set comprises a plurality of first training samples, each first training sample at least comprising a first game status data sample and a strategic intention label and an action label in response to the first game status data sample;
training the strategy model based on the training sample set, to obtain a trained strategy model;
wherein training the strategy model based on the training sample set to obtain a trained strategy model comprises:
inputting a first game status data sample of the training sample set into the strategy model to obtain a predicted strategic intention in response to the first game status data sample;
obtaining a corresponding predicted response action, according to the first game status data sample and the predicted strategic intention or the strategic intention label, and training the strategy model according to the predicted strategic intention, the predicted response action and the strategic intention label and action label in the first training sample, until a target loss function of the strategy model is minimized;
wherein the target loss function comprises a first loss function and a second loss function, the first loss function is a loss function between the predicted strategic intention and the strategic intention label, and the second loss function is a loss function between the predicted response action and the action label.

6. The method according to claim 1, wherein the determining a communicated strategic intention of a target object according to a current game status data and communication information of the target object comprises:
inputting the game status data and the communication information of the target object into a pre-trained intention prediction model to obtain a communicated target strategic intention of the target object; wherein, the intention prediction model is trained with a plurality of second training samples, each second training sample comprising a second game status data sample, a communication information sample, and a communicated strategic intention label.

7. The method according to claim 1, wherein the communication information comprises at least one of the following: inputted text or audio information, signal information inputted for a shortcut communication control, and preset communication information corresponding to a specified behavior;
the game status data characterizing game related description information, comprising at least one of the following: game description information of the target object, game description information of the virtual object, and game environment description information.

8. The method according to claim 1, wherein determining the communication target strategic intention of the target object according to a current game status data and communication information of the target object comprises:
during a game combat, determining the communicated strategic intention of the target object according to a current game status data and communication information of the target object, wherein the game combat at least comprises an own team and an enemy team, the own team comprising one or more target objects and one or more virtual objects, and the enemy team comprising a plurality of game objects.

9. The method according to claim 1, wherein determining a communicated strategic intention of the target object according to a current game status data and communication information of the target object comprises: when the communication information of a plurality of target objects is obtained during the game combat, determining a communicated strategic intention of each target object respectively;
determining a target strategic intention of the virtual object according to the initial strategic intention and the communicated strategic intention comprises: determining a target strategic intention of the virtual object for each target object according to the initial strategic intention and the communicated strategic intention of each target object;
determining a response action of the virtual object based on the target strategic intention and controlling the virtual object to perform the response action, comprises: determining, according to a preset rule, the response action of the virtual object based on a target strategic intention of the virtual object for each target object respectively, and controlling the virtual object to perform a response action for each target object respectively.

10. A device for combat control, comprising:
a first determination module, configured to determining, according to current game status data and communication information of the target object, a communicated strategic intention of a target object, wherein the communicated strategic intention characterizes a combat target expressed by the communication information;
a second determination module, configured to determining, according to the game status data, an initial strategic intention of a virtual object in response to the game state data;
a third determination module, configured to determining, according to the initial strategic intention and the communicated strategic intention, the target strategic intention of the virtual object;
a fourth determination module, configured to determining a response action of the virtual object based on the target strategic intention;
a control module, configured to controlling the virtual object to perform the response action.

11. An electronic device, comprising: one or more processors; one or more memories coupled to the one or more processors and having computer-executable instructions stored thereon, the computer-executable instructions, when executed by the one or more processors, causing the device to perform the method according to claim 1.

12. A computer readable storage medium having computer-executable instructions stored thereon, the computer-executable instructions, when executed by a processor, causing the processor to perform the method according to claim 1.
